(19) United States
(12) Patent Application Publication
(10) Pub. No.: US 2024/0272839 A1
(43) Pub. Date: Aug. 15, 2024

(54) PRINTER, CONTROL METHOD THEREFOR, AND STORAGE MEDIUM STORING CONTROL PROGRAM THEREFOR

(71) Applicant: CANON KABUSHIKI KAISHA, Tokyo (JP)

(72) Inventor: TORU WAKANA, Chiba (JP)

(21) Appl. No.: 18/418,461

(22) Filed: Jan. 22, 2024

(30) Foreign Application Priority Data
Feb. 14, 2023 (JP) 2023-020734

(51) Int. Cl. G06F 3/12

(52) U.S. Cl. CPC G06F 3/1215; G06F 3/1254

(57) ABSTRACT

A printer capable of giving a notification of a print time when a print job is received with a time period for executing printing being designated. The printer includes a reception unit configured to receive a print job in which a time period for executing printing is designated, a time determination unit configured to determine a print time of the print job in the printer based on the time period and a reference value in the time period, and a time notification unit configured to give notice of the print time.

### BACKGROUND OF THE INVENTION

### Field of the Invention

The present invention relates to a printer, a control method therefor, and a storage medium storing a control program therefor.

### Description of the Related Art

In a field of industrial printing, a customer orders a print task to a print company by designating print data and delivery deadline. On the other hand, the print company manages a print schedule and meets the delivery deadline for the print task requested by each customer. Japanese Laid-Open Patent Publication No. 2013-49223 discloses an information terminal capable of transmitting print data in which an execution time for executing a print job is designated when the print data is transmitted to a printer (an image forming apparatus). The printer disclosed in this publication can execute a print job on the basis of the execution time. Thus, the print schedule can be easily managed. In addition, an image forming apparatus capable of designating end of printing at one time (pinpoint), such as 18:00 or 19:00, and an image forming apparatus capable of designating the end of printing in a time period, such as 18:00 to 19:00, are also known. The latter image forming apparatus uses a printer driver (IPP Production Print Enhanced Function v2.0 (PPX)) that runs on an industry standard protocol, such as IPP (Internet Printing Protocol).

However, when the timing at which printing ends is designated by the print end time period, the print company may be difficult to accurately grasp the print end time of the printed matter in the print end time period because there is a temporal range in the print end time. As a result, the printing company does not know when to go to the image forming apparatus to pick up the printed matter. For example, when the print end time period is designated by “evening” and the “evening” is defined as “18:00 to 20:00”, it is unclear when the finishing of the printed matter ends between 18:00 and 20:00.

### SUMMARY OF THE INVENTION

The present invention provides a mechanism capable of giving a notification of a print time when a print job is received with a time period for executing printing being designated.

Accordingly, an aspect of the present invention provides a printer including a reception unit configured to receive a print job in which a time period for executing printing is designated, a time determination unit configured to determine a print time of the print job in the printer based on the time period and a reference value in the time period, and a time notification unit configured to give notice of the print time.

According to the present invention, when a print job is received with a time period for executing printing being designated, a notification of a print time can be given.

Further features of the present invention will become apparent from the following description of exemplary embodiments with reference to the attached drawings.

### BRIEF DESCRIPTION OF THE DRAWINGS

FIG. 1 is a configuration diagram showing an example of an image forming apparatus.

FIG. 2 is a block diagram showing a configuration of a controller of the image forming apparatus and a configuration of a host computer that is an external device.

FIG. 3 is a view showing an example of a setting screen for setting a reference value in a print end time period.

FIG. 4 is a view showing a breakdown (configuration) of a print job.

FIG. 5 is a view showing an example of a setting screen for setting conditions in a printer driver.

FIG. 6A to FIG. 6D are tables each of which shows relationships between keywords indicating the print end time periods, time periods set as the print end time periods, and initial values of the print end times.

FIG. 7A and FIG. 7B are tables each of which shows relationships between names of print jobs for which the print end time periods are designated, the keywords indicating the print end time periods, and printing requirement times required for print executions. FIG. 7C to FIG. 7E are tables each of which shows relationships between the names of the print jobs and print end times at which the print executions end.

FIG. 8 is a flowchart showing a process of setting an initial value of a print end time.

FIG. 9 is a flowchart showing a process of determining a print end time.

FIG. 10 is a flowchart showing the process in a step S913 (subroutine) in the flowchart shown in FIG. 9.

FIG. 11 is a flowchart showing a process of displaying a print time.

FIG. 12 is a table (modification) showing the relationships between the names of the print jobs for which the print end time periods are designated, the printing requirement time required for print executions, and the print end times at which the print executions end.

### DESCRIPTION OF THE EMBODIMENTS

Hereafter, embodiments according to the present invention will be described in detail by referring to the drawings. However, the configurations described in the following embodiments are merely examples, and the scope of the present invention is not limited by the configurations described in the embodiments. For example, each unit constituting the present invention can be replaced with any configuration capable of exhibiting the same function. In addition, an arbitrary constituent may be added.

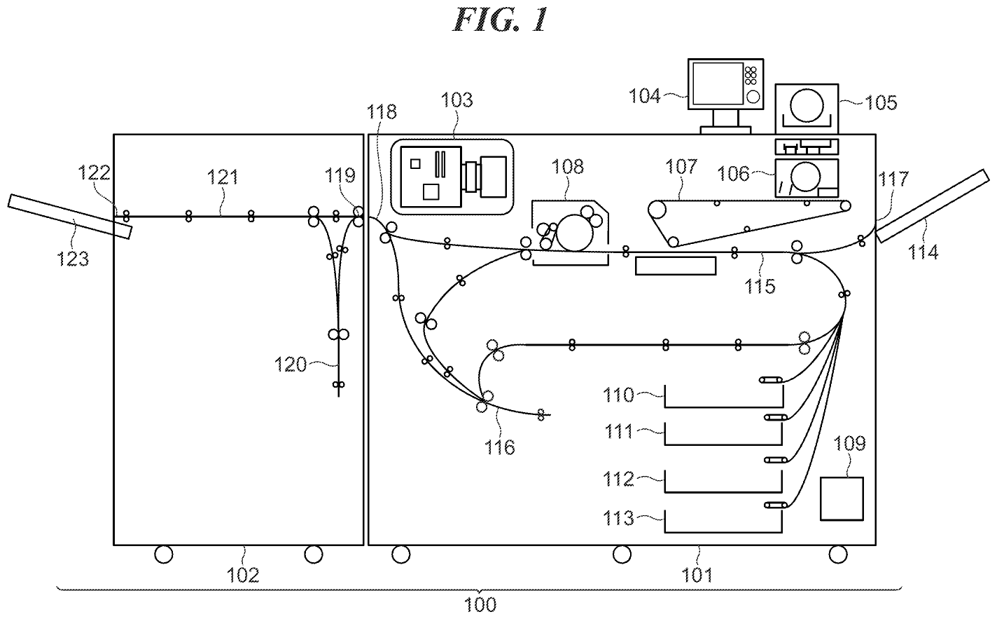

FIG. 1 is a configuration diagram showing an example of an image forming apparatus. As shown in FIG. 1, the image forming apparatus 100 includes a printer 101 and a finisher 102. The printer 101 forms an image by printing. The finisher 102 discharges a sheet printed by the printer 101.

The printer 101 includes a controller 103, an operation unit 104, a toner supply unit 105, an image forming unit 106, an intermediate transfer belt 107, a fixing device 108, and an excess toner collection unit 109. The printer 101 also includes sheet feeding devices 110 to 114, a sheet conveyance section 115, a switchback section 116, a sheet input port 117, and a sheet discharge section 118.

The controller 103 is a computer that controls various operations of the image forming apparatus 100. The operation unit 104 is operated by a user to issue an instruction to the image forming apparatus 100. The operation unit 104 includes, for example, a touch panel and hard keys. The operation unit 104 also has a function as a display unit that displays information about the image forming apparatus 100, for example.

The toner supply unit 105 supplies toner to the image forming unit 106. The toner supply unit 105 has an openable and closable door. This enables replacement and replenishment of the toner to the toner supply unit 105. The image forming unit 106 forms an image on the intermediate transfer belt 107 with the toner supplied from the toner supply unit 105. The image on the intermediate transfer belt 107 is transferred to a sheet.

The fixing device 108 fixes the toner to the sheet by applying heat and pressure to the sheet to which the image has been transferred. The excess toner collection unit 109 collects the toner that has not been transferred to the sheet. The sheet feeding devices 110, 111, 112, and 113 are arranged in order from the top, and supply sheets from the respective arrangement positions. The sheet feeding device 114 is used for manual feeding of a sheet.

The sheet conveyance section 115 conveys a sheet supplied from any of the sheet feeding devices 110 to 114. During the conveyance, the sheet is subjected to a toner transfer process and a fixing process. The switchback section 116 reverses the sheet. This enables two-sided printing. A sheet is input from the sheet feeding device 114 to the sheet input port 117. The sheet subjected to the fixing process is discharged from the sheet discharge section 118 to the finisher 102.

The finisher 102 includes a sheet input port 119, a sheet switchback section 120, a sheet conveyance section 121, a sheet discharge section 122, and a sheet discharge tray 123. The sheet from the sheet discharge section 118 is input to the sheet input port 119. The sheet switchback section 120 reverses a sheet. The sheet conveyance section 121 conveys a sheet. The sheet conveyed by the sheet conveyance section 121 is discharged from the sheet discharge section 122. The sheet discharged from the sheet discharge section 122 is stacked on the sheet discharge tray 123. The image forming apparatus 100 is not limited to a single function printer (SFP) having a printer function only, and may be a multiple function printer (MFP) having a facsimile function and a scanner function in addition to the printer function.

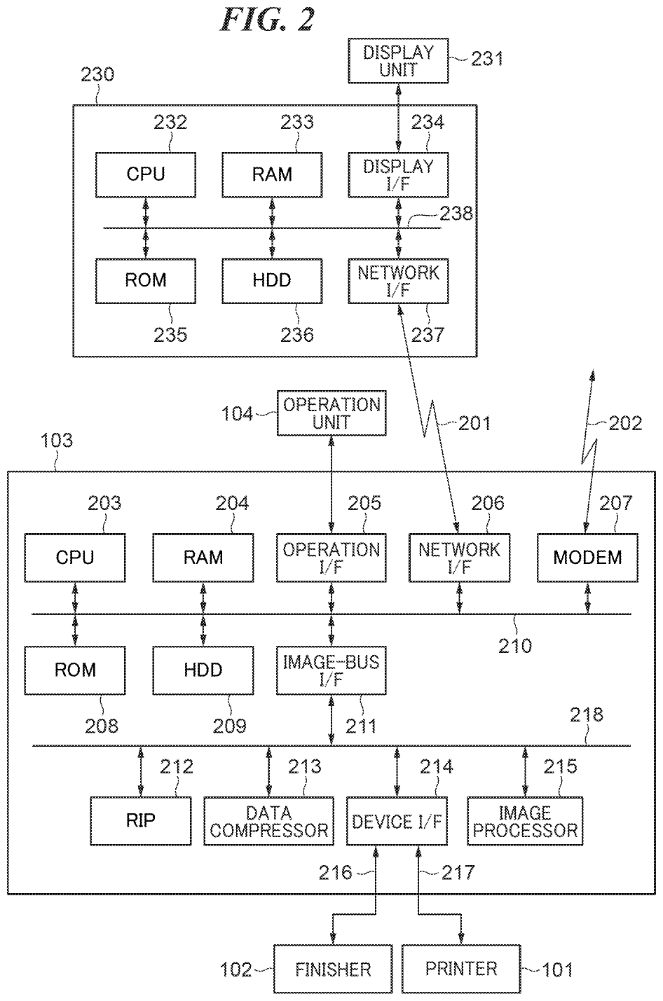

FIG. 2 is a block diagram showing a configuration of the controller of the image forming apparatus and a configuration of a host computer that is an external device. As shown in FIG. 2, the controller 103 of the image forming apparatus 100 includes a CPU 203, a RAM 204, an operation interface (I/F) 205, a network interface 206, a modem 207, a ROM 208, and a hard disk drive (HDD) 209, which are communicably connected to each other via a bus 210. The controller 103 also includes an image-bus interface 211, a rasterizing unit (RIP, a Raster Image Processor) 212, a data compressor 213, a device interface 214, and an image processor 215, which are communicably connected to each other via a bus 218.

The CPU 203 is a computer that controls the entire image forming apparatus 100. The RAM 204 is used as a reception buffer for temporarily storing data received from an external device, an image data buffer for temporarily storing image data rasterized by the RIP 212, and the like.

The operation interface 205 communicably connects the operation unit 104 and the controller 103. The network interface 206 connects the controller 103 to a network 201. The modem 207 connects the controller 103 to a telephone line 202.

The ROM 208 stores various programs and date. The programs include, for example, a program for causing the CPU 203 to achieve the units of the printer 101 (steps of a control method for the printer). The HDD 209 is a nonvolatile storage device capable of storing various kinds of date for a long period of time.

The image-bus interface 211 connects the bus 210 and the bus 218. The RIP 212 converts page description language (PDL) data input from an external apparatus, such as the host computer 230, into bitmap image data. The data compressor 213 is used for data compression. The device interface 214 is communicably connected to the finisher 102 via a bus 216 and is communicably connected to the printer 101 via a bus 217. The image processor 215 applies various image processes to the bitmap image generated in the RIP 212.

As shown in FIG. 2, the host computer 230 includes a CPU 232, a RAM 233, a display interface 234, a ROM 235, an HDD 236, and a network interface 237, which are communicably connected to each other via a bus 238. The host computer 230 also includes a display unit 231. The display unit 231 displays, for example, information about a printer driver described later and a print time. The print time is a print end time at which printing ends or a print start time at which printing starts.

The CPU 232 is a computer that controls the entire host computer 230. In this embodiment, the printer driver is deployed from the HDD 236 to the RAM 233 and executed by the CPU 232. The display interface 234 connects the display unit 231 to the CPU 232. The ROM 235 stores various programs and data. The HDD 236 is a nonvolatile storage device capable of storing various kinds of date for a long period of time.

The network interface 237 connects the controller 103 to the network 201. Thus, the image forming apparatus 100 and the host computer 230 are communicably connected to each other via the network 201. In this connection state, a print job is transmitted from the network interface 237 (a transmission unit) and received by the network interface 206 (a reception unit, a reception step).

The image forming apparatus 100 executes a print job to perform printing. In the print job, a time period in which the image forming apparatus 100 is desired to execute printing (hereinafter, referred to as “desired execution time period (desired time period)”) is designated. The desired execution time period is a print end time period in which printing ends or a print start time period in which printing starts. In this embodiment, the print end time period is representatively handled among the print end time period and the print start time period. In accordance with this, the print end time is representatively handled as the above-described print time among the print end time and the print start time. The host computer 230 is a terminal apparatus, such as a desktop or notebook personal computer, a tablet terminal, or a smartphone.

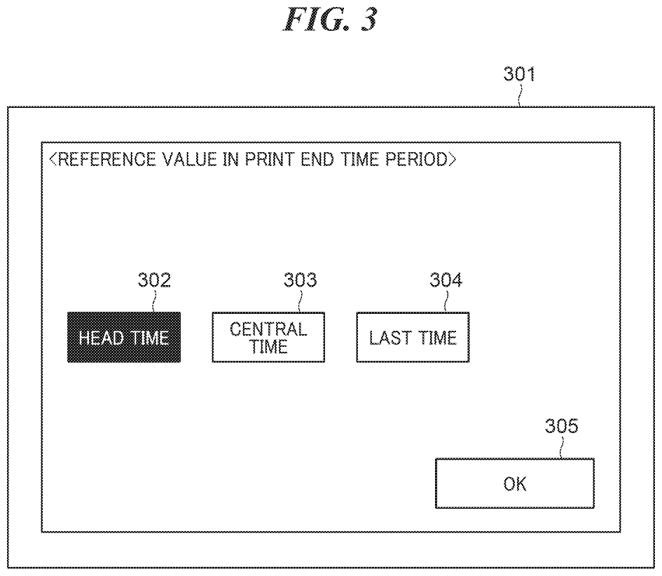

FIG. 3 is a view showing an example of a setting screen for setting a reference value in a print end time period. The setting screen 301 shown in FIG. 3 is displayed on the touch panel constituting the operation unit 104. A user can set a reference value as a reference in the print end time period (desired execution time period) on the setting screen 301.

The “reference value” is any one of a head time (beginning time), a central time (middle time), and a last time (final time) in the print end time period. An initial value of a print end time in each print end time period is set on the basis of the reference value.

For example, in a state where a keyword of the print end time period is “evening” to which the time period of “18:00 to 20:00” is set, when the reference value is the head time, the initial value of the print end time becomes “18:00”. When the reference value is the central time, the initial value becomes “19:00”. When the reference value is the last time, the initial value becomes “20:00”. For example, in a state where a keyword of the print end time period is “morning” to which the time period of “7:00 to 9:00” is set, when the reference value is the head time, the initial value becomes “7:00”. When the reference value is the central time, the initial value becomes “8:00”. When the reference value is the last time, the initial value becomes “9:00”.

The setting screen 301 includes setting keys 302 to 304 and an OK key 305. The setting key 302 is a key (button) for setting the reference value to the “head time”. For example, when the setting key 302 is operated in the state where the “evening” is selected as the keyword of the print end time period, the initial value of the print end time is set to “18:00”. Further, for example, the setting key 302 is operated in the state where the “morning” is selected as the keyword of the print end time period, the initial value is set to “7:00”.

The setting key 303 is a key for setting the reference value to the “central time”. For example, when the setting key 303 is operated in the state where the “evening” is selected as the keyword of the print end time period, the initial value of the print end time is set to “19:00”. Further, for example, the setting key 303 is operated in the state where the “morning” is selected as the keyword of the print end time period, the initial value is set to “8:00”.

The setting key 304 is a key for setting the reference value to the “last time”. For example, when the setting key 304 is operated in the state where the “evening” is selected as the keyword of the print end time period, the initial value of the print end time is set to “20:00”. Further, for example, the setting key 304 is operated in the state where the “morning” is selected as the keyword of the print end time period, the initial value is set to “9:00”. In FIG. 3, the setting key 302 is displayed in reverse among the setting keys 302 to 304. This display state indicates that the reference value is set to the “head time”.

Operation of the OK key 305 validates the setting state on the setting screen 301 and closes the setting screen 301. The setting screen 301 configured as described above allows to change the reference value according to the keyword and to change the reference value even in one keyword. That is, the reference value is changeable. This enables selection of a desired reference value as appropriate.

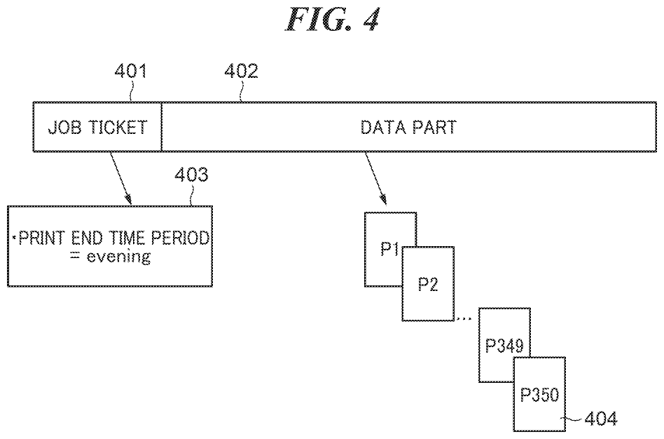

FIG. 4 is a view showing a breakdown (configuration) of a print job. FIG. 4 shows PDL data input from the host computer 230 to the image forming apparatus 100 via the network 201 as an example of a print job. The print job is not limited to this, and may be, for example, a copy job read by a scanner (not shown) of the image forming apparatus 100 or a print job temporarily stored in a storage device, such as the HDD 209.

As shown in FIG. 4, the print job includes a job ticket 401 and a data part 402. A print setting 403, such as a keyword of a print end time period, is set in the job ticket 401. The job ticket 401 is written in a job control language in this embodiment.

In the print setting 403 in FIG. 4, the “evening” is set as the keyword of the print end time period. In addition to the “evening”, keywords, such as the “morning”, “afternoon”, and “night”, can be set. The data part 402 is page description language (PDL) data in this embodiment. The total page number of page data 404 included in the data part 402 in FIG. 4 is 350.

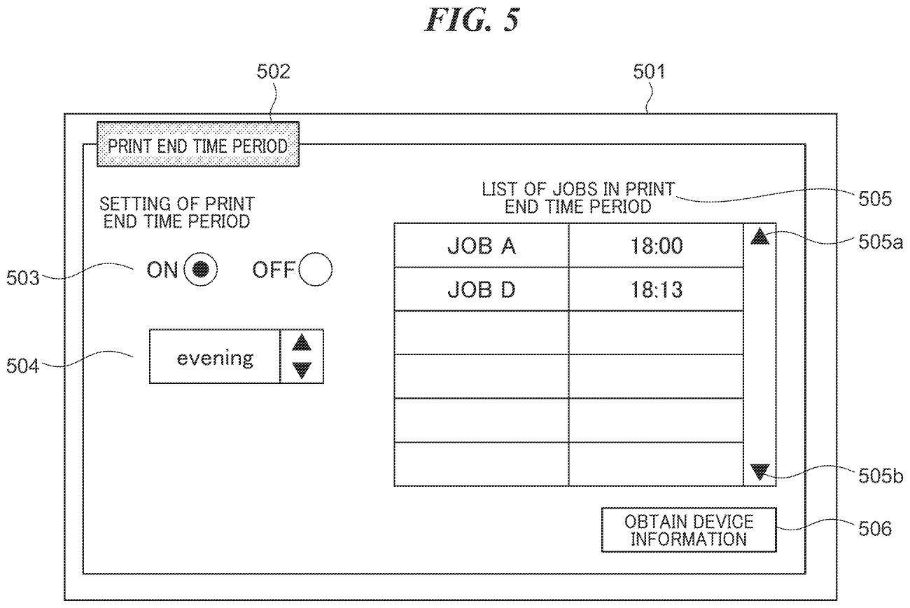

FIG. 5 is a view showing an example of a setting screen for setting conditions of the printer driver. The setting screen 501 shown in FIG. 5 is displayed on the display unit 231 of the host computer 230. The setting screen 501 includes a tab 502, radio buttons 503, an option 504, a list 505, and a button 506.

The tab 502 indicates that “print end time period setting” for setting a print end time period by the printer driver is selected. The radio buttons 503 are used for switching between enabling and disabling the setting of the print end time period, that is, for setting ON/OFF of the setting function of the print end time period. When the setting of the print end time period is enabled, an ON button of the radio buttons 503 is checked. And when the setting of the print end time period is disabled, that is, when the setting of the print end time period is not performed, an OFF button of the radio buttons 503 is checked. In FIG. 5, the ON button of the radio buttons 503 is checked.

The option 504 allows selection of the print end time period from among a plurality of options. The options include the “morning”, “afternoon”, “evening”, “night”, and the like, and any one can be selected from among these options. In FIG. 5, the “evening” is selected in the option 504.

The list 505 indicates print jobs of which printings end within the print end time period. The list 505 includes job names and print end times. In FIG. 5, a print job having a job name “job A” and a print end time “18:00” and a print job having a job name “job D” and a print end time “18:13” are displayed in the list 505. Further, the user can scroll the list 505 by operating a button 505a or a button 505b in the list 505. Only print jobs associated with a user ID shall be displayed in the list 505. By operating the button 506, information about a print job stored in the HDD 209 in the image forming apparatus 100 can be obtained and reflected to the list 505.

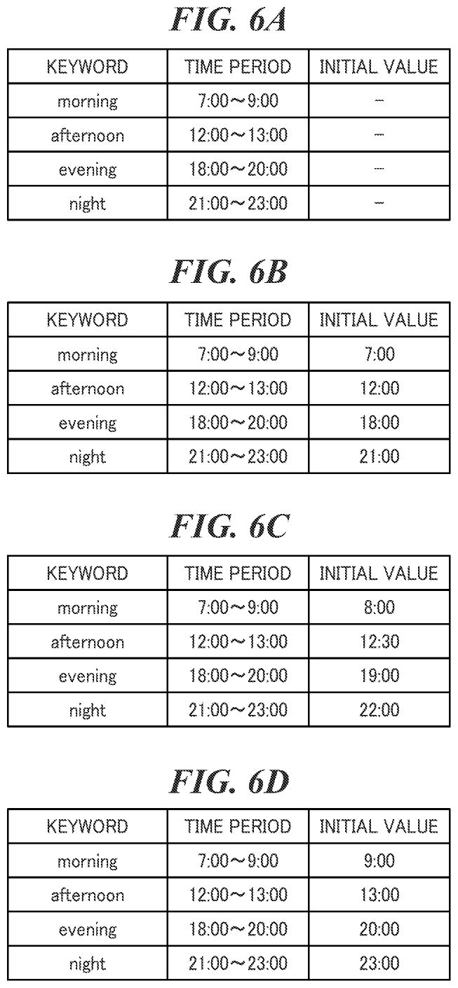

FIG. 6A to FIG. 6D are tables each of which shows relationships between keywords indicating the print end time periods, time periods set as the print end time period, and initial values of the print end times. FIG. 6A shows a state where a print end time period predicted to be designated to a print job is set (registered) and an initial value is not set (unregistered) corresponding to each keyword.

The keywords and the print end time periods are associated with each other in advance. The keyword “morning” is associated with the print end time period “7:00 to 9:00”. The keyword “afternoon” is associated with the print end time period “12:00 to 13:00”. The keyword “evening” is associated with the print end time period “18:00 to 20:00”. The keyword “night” is associated with the print end time period “21:00 to 23:00”. The table shown in FIG. 6A shall be stored in the HDD 209 in advance.

FIG. 6B shows a state where the initial values are set when the reference value in the print end time period becomes the head time by selecting the setting key 302 (see FIG. 3) on the setting screen 301. The initial values are obtained on the basis of the reference value. The print end time period “7:00 to 9:00” and the initial value “7:00” are set for the keyword “morning”. The print end time period “12:00 to 13:00” and the initial value “12:00” are set for the keyword “afternoon”. The print end time period “18:00 to 20:00” and the initial value “18:00” are set for the keyword “evening”. The print end time period “21:00 to 23:00” and the initial value “21:00” are set for the keyword “night”. The table shown in FIG. 6B shall be stored in the HDD 209.

FIG. 6C shows a state where the initial values are set when the reference value in the print end time period becomes the central time by selecting the setting key 303 (see FIG. 3) on the setting screen 301. The print end time period “7:00 to 9:00” and the initial value “8:00” are set for the keyword “morning”. The print end time period “12:00 to 13:00” and the initial value “12:30” are set for the keyword “afternoon”. The print end time period “18:00 to 20:00” and the initial value “19:00” are set for the keyword “evening”. The print end time period “21:00 to 23:00” and the initial value “22:00” are set for the keyword “night”. The table shown in FIG. 6C shall be stored in the HDD 209.

FIG. 6D shows a state where the initial values are set when the reference value in the print end time period becomes the last time by selecting the setting key 304 (see FIG. 3) on the setting screen 301. The print end time period “7:00 to 9:00” and the initial value “9:00” are set for the keyword “morning”.

The print end time period “12:00 to 13:00” and the initial value “13:00” are set for the keyword “afternoon”. The print end time period “18:00 to 20:00” and the initial value “20:00” are set for the keyword “evening”. The print end time period “21:00 to 23:00” and the initial value “23:00” are set for the keyword “night”. The table shown in FIG. 6D shall be stored in the HDD 209.

As described above, in the image forming apparatus 100, there are a plurality of different print end time periods, and the reference value can be set for each print ending time period (desired execution time period). Thus, the reference value can be set according to the needs of the user. The setting screen 301 is used for setting the reference value.

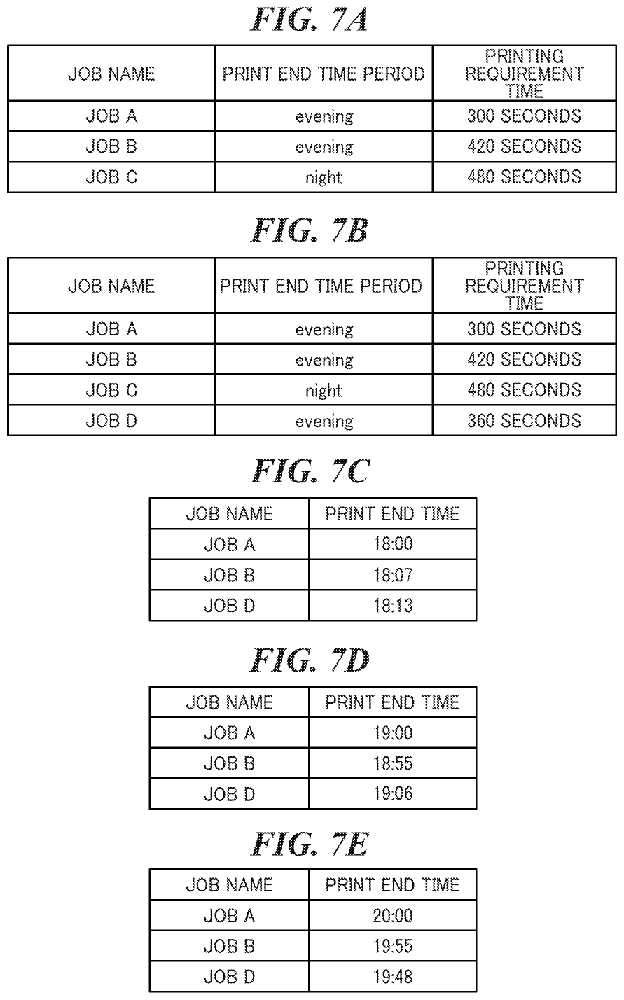

FIG. 7A to FIG. 7E are tables each of which shows relationships between names of print jobs for which the print end time periods are designated, printing requirement times required for print executions, and print end times at which print executions end. The table shown in FIG. 7A includes “job A”, “job B”, and “job C” as names of print jobs. The print end time period of the job A is the “evening”, the print end time period of the job B is the “evening”, and the print end time period of the job C is the “night”. Printing requirement time of the job A is “300 seconds”, printing requirement time of the job B is “420 seconds”, and the printing requirement time of the job C is “480 seconds”. Although the unit of the printing requirement time is “second” in the table shown in FIG. 7A, the unit is not limited to this and may be “minute”, for example. The table shown in FIG. 7A shall be stored in the HDD 209 and can be notified to the host computer 230.

The table shown in FIG. 7B includes “job D” as the name of print job in addition to the table shown in FIG. 7A. The print end time period of the job D is the “evening”, and the printing requirement time thereof is “360 seconds”.

The table shown in FIG. 7C includes the “job A”, “job B”, and “job D” as the names of the print jobs. The reference value of the print end time period for the keyword “evening” is set to the head time. In this state, the print end time of the job A is “18:00”, the print end time of the job B is “18:07”, and the print end time of the job D is “18:13”. The table shown in FIG. 7C shall be stored in the HDD 209.

The table shown in FIG. 7D includes the “job A”, “job B”, and “job D” as the names of the print jobs as with the table shown in FIG. 7C. The reference value of the print end time period for the keyword “evening” is set to the central time. In this state, the print end time of the job A is “19:00”, the print end time of the job B is “18:55”, and the print end time of the job D is “19:06”. The table shown in FIG. 7D shall be stored in the HDD 209.

The table shown in FIG. 7E includes the “job A”, “job B”, and “job D” as the names of the print jobs as with the tables shown in FIG. 7C and FIG. 7D. The reference value of the print end time period for the keyword “evening” is set to the last time. In this state, the print end time of the job A is “20:00”, the print end time of the job B is “19:55”, and the print end time of the job D is “19:48”. The table shown in FIG. 7E shall be stored in the HDD 209.

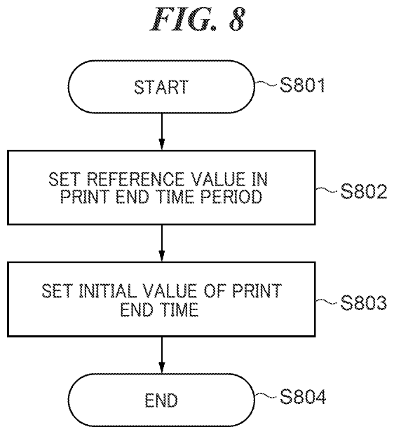

FIG. 8 is a flowchart showing a process of setting an initial value of the print end time. Each process in the flowchart shown in FIG. 8 is achieved by the CPU 203 reading a program stored in a storage unit, such as the HDD 209, to the RAM 204 and executing the program. The timing of setting the reference value in the print end time period is not particularly limited. It is preferable that the setting is performed once, for example, when the image forming apparatus 100 is installed or when the power of the image forming apparatus 100 is turned ON. As shown in FIG. 8, in a step S801, the CPU 203 starts execution of the program based on the flowchart shown in FIG. 8.

In a step S802, the CPU 203 causes the operation unit 104 to display the setting screen 301 (see FIG. 3) and receives a user operation on the setting screen 301, that is, selection of any one of the setting keys 302 to 304. Then, the CPU 203 stores the selection result of any one of the setting keys 302 to 304 as a reference value in the HDD 209 (storage unit). In the state shown in FIG. 3, the setting key 302 is selected and the “head time” is set as the reference value.

In a step S803, the CPU 203 reads the print end time period (see FIG. 6A) from the HDD 209. Then, the CPU 203 calculates the initial value of the print end time on the basis of the reference value set in the step S802 and stores the initial value in the HDD 209. This results in the table shown in FIG. 6B. Note that, when the setting key 303 on the setting screen 301 is selected in the step S802, the table shown in FIG. 6C is obtained, and when the setting key 304 on the setting screen 301 is selected in step S802, the table shown in FIG. 6D is obtained.

In a step S804, the CPU 203 ends the execution of the program based on the flowchart shown in FIG. 8.

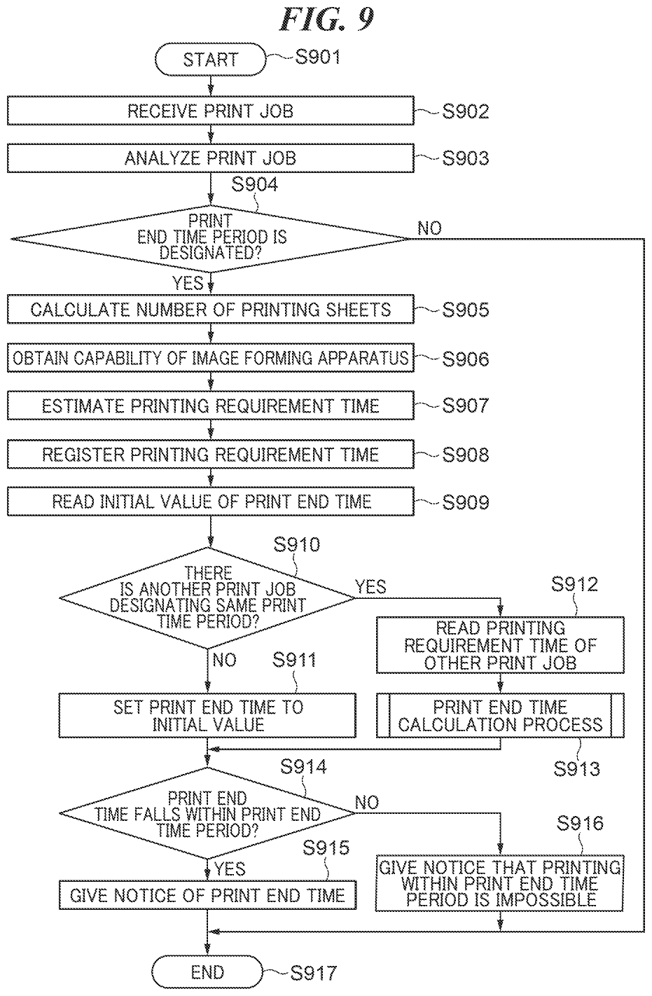

FIG. 9 is a flowchart showing a process of determining a print end time. Each process in the flowchart shown in FIG. 9 is achieved by the CPU 203 reading a program stored in a storage unit, such as the HDD 209, to the RAM 204 and executing the program. As shown in FIG. 9, in a step S901, the CPU 203 starts execution of the program based on the flowchart shown in FIG. 9.

In a step S902, the CPU 203 receives a print job from the host computer 230 via the network 201 and network interface 206. The CPU 203 stores the print job in the HDD 209.

In a step S903, the CPU 203 reads the print job stored in the HDD 209 in the step S902 and analyzes the print job. In this analysis, the CPU 203 extracts the print setting 403 from the job ticket 401 (see FIG. 4) in the print job and stores the extracted print setting in the HDD 209. The CPU 203 also analyzes the PDL data of the data part 402 (see FIG. 4) in the print job, converts the PDL data into intermediate date (not shown), and stores the intermediate date in the HDD 209.

In a step S904, the CPU 203 determines whether the keyword of the print end time period (print end time period information) is included in the print setting 403 extracted in the step S903, that is, whether the print end time period of the print job is designated. As a result of the determination in the step S904, when it is determined that the keyword of the print end time period is included, the process proceeds to a step S905. In the meantime, when it is determined in the step S904 that the keyword of the print end time period is not included, the process proceeds to a step S917.

In the step S905, the CPU 203 calculates the number of printing sheets of the data part 402. In this calculation, the CPU 203 first reads the intermediate dataset stored in the HDD 209 in the step S903. Next, the CPU 203 generates image data (not shown) based on the intermediate image using the RIP unit 212. Next, the CPU 203 calculates the total number of pages on the basis of the image data. In this embodiment, the total number of pages is 350, and the number of printing sheets in an one-sided printing is calculated as 350. It is preferable that the CPU 203 stores the image date (not shown) in the HDD 209.

In a step S906, the CPU 203 obtains capability information about the image forming apparatus 100. The “capability information” is information relating to a sheet discharge speed (the number of sheets discharged per minute) of the image forming apparatus 100, a sheet discharge time (a time required for discharging one sheet) of the image forming apparatus 100, and the like. In this embodiment, the sheet discharge speed shall be 60 (sheets/min), and the sheet discharge time shall be 10 (seconds/sheet). The capability information is stored in the HDD 209 in advance. The CPU 203 can read and obtain the capability information from the HDD 209.

In a step S907, the CPU 203 predicts and obtains the printing requirement time required for execution of the print job on the basis of the number of printing sheets calculated in the step S905 and the capability information obtained in the step S906. Since the number of printing sheets is 350 (sheets), the sheet discharge speed is 60 (sheets/minute), and the sheet discharge time is 10 (seconds/sheet) in this embodiment, the printing requirement time is 360 (seconds). Although the CPU 203 has a function as an obtainment unit that obtains the printing requirement time in this embodiment, this is not limiting. For example, a section that functions as the obtainment unit may be provided separately from the CPU 203.

In a step S908, the CPU 203 registers the printing requirement time obtained in the step S907. Thus, the table shown in FIG. 7B is obtained, for example. The table shown in FIG. 7B is stored in the HDD 209. In this embodiment, the table shown in FIG. 7A has been already stored, and the table shown in FIG. 7B is obtained by adding the “job D” to the table shown in FIG. 7A.

In a step S909, the CPU 203 reads the initial value of the print end time from among the tables shown in FIG. 6B to FIG. 6D stored in the HDD 209. For example, when the “evening” is designated as the keyword of the print end time period and the “head time” is designated as the reference value in the print end time period, the initial value “18:00” is read from the table shown in FIG. 6B.

In a step S910, the CPU 203 determines whether a print job for which the same print end time period as that of the print job received in the step S902 is designated already exists in addition to the print job received in the step S902. In this determination, the CPU 203 first reads the table shown in FIG. 7B stored in the HDD 209.

Next, the CPU 203 determines whether there is another print job for which the same print end time period (evening) as that of the print job received in step S902 is designated in the table shown in FIG. 7B. For example, when the print job D is received in the step S902, the job A and job B for which the same print end time period as that of the job D is designated already exist in the table shown in FIG. 7B in addition to the job D. Then, as a result of the determination in the step S910, when it is determined that there is no other print job, the process proceeds to a step S911. In the meantime, when it is determined in the step S910 that there is another print job, the process proceeds to a step S912.

In the step S911, the CPU 203 sets the print end time (print time) to the initial value read in the step S909. For example, when the initial value “18:00” is read from the table shown in FIG. 6B, the print end time is determined as “18:00”. After the execution of the step S911, the process proceeds to a step S914.

In the step S912 after the execution of the step S910, the CPU 203 reads the printing requirement times of the other print jobs determined to already exist in the step S910 and calculates the sum of these. For example, the job A and the job B for which the same print end time period as that of the job D is designated already exist in addition to the job D received in step S902 in the table shown in FIG. 7B. Then, the printing requirement time “300 seconds” of the job A and the printing requirement time “420 seconds” of the job B are read, and the total is calculated as “720 seconds”.

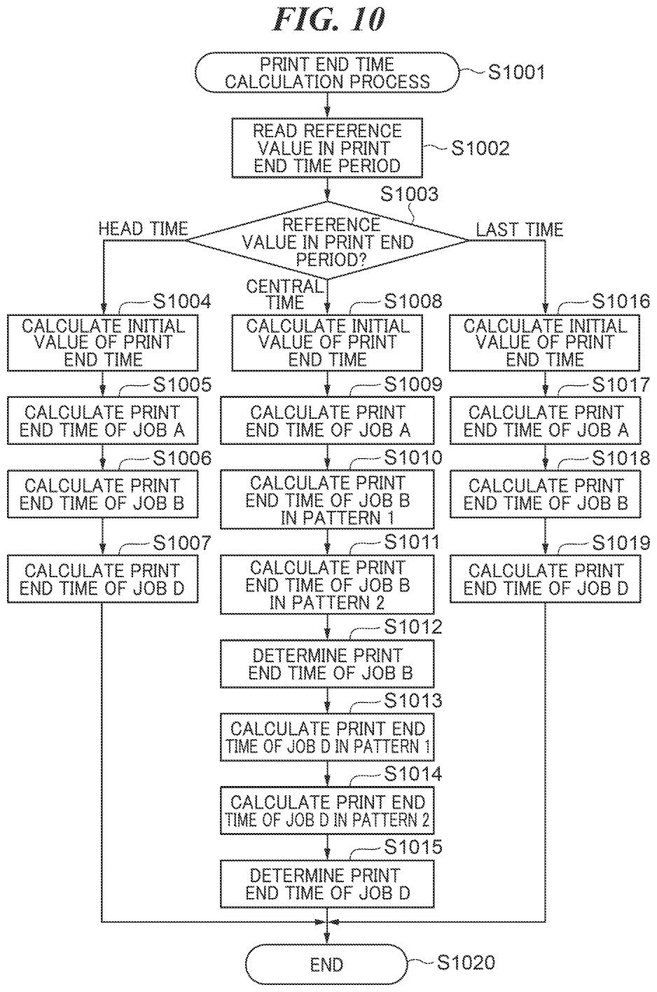

In the step S913, the CPU 203 calculates (determines) the print end time on the basis of the initial value read in the step S909 and the printing requirement time calculated in the step S912. The details of the step S913 will be described later with reference to FIG. 10. After the execution of the step S913, the process proceeds to the step S914.

In the step S914, the CPU 203 determines whether the print end time calculated in the step S911 or step S913 falls within the print end time period. In this embodiment, since the keyword of the print end time period is “evening”, it is determined whether the print end time falls within the range of “18:00 to 20:00” set by the keyword. Then, as a result of the determination in the step S914, when it is determined that the print end time falls within the print end time period, the process proceeds to a step S915. In the meantime, as a result of the determination in the step S914, when it is determined that the print end time does not fall within the print end time period, the process proceeds to a step S916.

In the step S915, the CPU 203 notifies the host computer 230 and the operation unit 104 of the print end time calculated in the step S913 via the network interface (a time notification unit) 206 (a time notification step). Thus, the notification content that is the print end time is displayed. The host computer 230 may be notified of the print end time regardless of the presence or absence of the notification request from the host computer 230 (similar in the step S916).

In the step S916, the CPU 203 notifies the notification destinations that “the printing within the print end time period is impossible”. The notification destinations are the host computer 230, the operation unit 104, etc. as with the notification destinations in the step S915. Thus, the notification content that is “the printing within the print end time period is impossible” is displayed as an image.

As described above, in this embodiment, when the print end time is included in the print end time period, the notification destinations are notified of the print end time, and when the print end time is not included in the print end time period, the notification destinations are notified of this matter or that the printing is impossible. This allows the user to know the print end time or know that the printing within the print end time period is impossible. The method of giving the notification content is not limited to the method of displaying as an image. For example, a method using a sound emitted from a loud speaker, a method using light emitted from a pilot lamp, or the like may be employed.

In the step S917, the CPU 203 ends the execution of the program based on the flowchart shown in FIG. 9.

FIG. 10 is a flowchart showing the process (subroutine) in the step S913 of the flowchart shown in FIG. 9. Each process in the flowchart shown in FIG. 10 is achieved by the CPU 203 reading a program stored in a storage unit, such as the HDD 209, to the RAM 204 and executing the program. As shown in FIG. 10, in a step S1001, the CPU 203 starts execution of the program based on the flowchart shown in FIG. 10.

In a step S1002, the CPU 203 reads the reference value in the print end time period set on the setting screen 301 (see FIG. 3) from the HDD 209.

In a step S1003, the CPU 203 determines whether the reference value read in the step S1002 is the first time, the central time, or the last time in the print end time period. As a result of the determination in the step S1003, when it is determined that the reference value is the head time, the process proceeds to a step S1004. As a result of the determination in the step S1003, when it is determined that the reference value is the central time, the process proceeds to a step S1008. As a result of the determination in the step S1003, when it is determined that the reference value is the last time, the process proceeds to a step S1016.

In the step S1004, the CPU 203 calculates an initial value of the print end time on the basis of the result of the determination in the step S1003. In this example, since the “evening” is designated as the keyword of the print end time period and the reference value is determined as the head time in the step S1003, the initial value is calculated as “18:00” (see FIG. 6B).

In a step S1005, the CPU 203 calculates the print end time of the “job A (another print job)”. Specifically, the CPU 203 calculates the print end time of the “job A” as the initial value “18:00” calculated in the step S1004. Then, the CPU 203 stores the table shown in FIG. 7C to which the calculation result is reflected in the HDD 209.

In a step S1006, the CPU 203 calculates the print end time of the “job B (another print job)”. In this calculation, the CPU 203 first calculates the print start time of the “job B” as “18:00” that is the print end time of the “job A”. Next, the CPU 203 reads the printing requirement time of the “job B” (see FIG. 7B) from the HDD 209. Next, the CPU 203 calculates the print end time “18:07” of the “job B” by adding the printing requirement time “420 seconds” of the “job B” to the print start time “18:00” of the “job B”. Then, the CPU 203 stores the table shown in FIG. 7C to which the calculation result is reflected in the HDD 209.

As described above, the print end time of the job B among the jobs A and B that are sequentially executed is obtained by adding the printing requirement time of the job B (the subsequent print job) to the print end time of the job A (the preceding print job) in the step S1006. Such determination is performed in the same manner in the subsequent steps. Although the print end time is representatively handled as the print time in this embodiment, the print start time may be used. In this case, the print start time of the subsequent print job among the print jobs that are sequentially executed is determined by adding the printing requirement time of the preceding print job to the print start time of the preceding print job.

In a step S1007, the CPU 203 calculates the print end time of the “Job D”. In this calculation, the CPU 203 first calculates the print start time of the “job D” as “18:07” that is the print end time of the “job B”. Next, the CPU 203 reads the printing requirement time of the “job D” (see FIG. 7B) from the HDD 209. Next, the CPU 203 calculates the print end time “18:13” of the “job D” by adding the printing requirement time “360 seconds” of the “job D” to the print start time “18:07” of the “job D”. Then, the CPU 203 stores the table shown in FIG. 7C to which the calculation result is reflected in the HDD 209. The print end times in the table shown in FIG. 7C are determined so that the print end times will fall within the print end time period and the execution time periods of the jobs A, B, and D will not overlap. After the execution of the step S1007, the process proceeds to a step S1020.

In the step S1008, the CPU 203 calculates an initial value of the print end time on the basis of the result of the determination in the step S1003. In this example, since the “evening” is designated as the keyword of the print end time period and the reference value is determined as the central time in the step S1003, the initial value is calculated as “19:00” (see FIG. 6C). The initial value may be a time close to “19:00”.

In a step S1009, the CPU 203 calculates the print end time of the “job A”. Specifically, the CPU 203 calculates the print end time of the “job A” as the initial value “19:00” calculated in the step S1008. Then, the CPU 203 stores the table shown in FIG. 7D to which the calculation result is reflected in the HDD 209. Further, the CPU 203 reads the printing requirement time of the “job A” (see FIG. 7B) from the HDD 209. Then, the CPU203 calculates the print start time “18:55” of the “job A” by subtracting the printing requirement time “300 seconds” of the “job A” from the print end time “19:00” of the “job A”.

In a step S1010, the CPU 203 calculates the print end time of the “job B” on the assumption that the “job B” is executed before the “job A” (pattern 1). In this case, the CPU 203 calculates the print end time of the “job B” as “18:55” that is the print start time of the “job A”. The CPU 203 stores the calculation result in the HDD 209. Further, the CPU 203 reads the printing requirement time of the “job B” (see FIG. 7B) from the HDD 209. Then, the CPU203 calculates the print start time “18:48” of the “job B” by subtracting the printing requirement time “420 seconds” of the “job B” from the print end time “18:55” of the “job B”.

In a step S1011, the CPU 203 calculates the print end time of the “job B” on the assumption that the “job B” is executed after the “job A” (pattern 2). In this case, the CPU 203 calculates the print start time of the “job B” as “19:00” that is the print end time of the “job A”. Further, the CPU 203 reads the printing requirement time of the “job B” (see FIG. 7B) from the HDD 209. Then, the CPU 203 calculates the print end time “19:07” of the “job B” by adding the printing requirement time “420 seconds” of the “job B” to the print start time “19:00” of the “job B”. The CPU 203 stores the calculation result in the HDD 209.

In a step S1012, the CPU 203 fixes (determines) the print end time of the “job B” on the basis of the print end time “18:55” of the “job B” calculated in the step S1010 and the print end time “19:07” of the “job B” calculated in the step S1011. Specifically, the CPU 203 compares the two print end times and determines the time that is closer to the initial value “19:00” calculated in the step S1008, that is, “18:55” as the print end time of the “job B”. Then, the CPU 203 stores the table shown in FIG. 7D to which the confirmation result is reflected in the HDD 209. In this case, the CPU 203 determines the print start time of the “job B” as “18:48”.

In a step S1013, the CPU 203 calculates the print end time of the “job D” assuming that the “job D” is executed before the “job B” (pattern 1). In this case, the CPU 203 calculates the print end time of the “job D” as “18:48” that is the print start time of the “job B”. Then, the CPU 203 stores the calculation result in the HDD 209. Further, the CPU 203 reads the printing requirement time of the “job D” (see FIG. 7B) from the HDD 209. Then, the CPU 203 calculates the print start time “18:42” of the “job D” by subtracting the printing requirement time “360 seconds” of the “job D” from the print end time “18:48” of the “job D”.

In a step S1014, the CPU 203 calculates the print end time of the “job D” assuming that the “job D” is executed after the “job A” and “job B” (pattern 2). In this case, the CPU203 calculates the print start time of the “job D” as “19:00” that is the print end time of the “job A” executed after the “job B”. Further, the CPU 203 reads the printing requirement time of the “job D” (see FIG. 7B) from the HDD 209. Then, the CPU 203 calculates the print end time “19:06” of the “job D” by adding the printing requirement time “360 seconds” of the “job D” to the print start time “19:00” of the “job D”. The CPU 203 stores the calculation result in the HDD 209.

In a step S1015, the CPU 203 determines the print end time of the “job D” on the basis of the print end time “18:48” of the “job D” calculated in the step S1013 and the print end time “19:06” of the “job D” calculated in the step S1014. Specifically, the CPU 203 compares the two print end times, and determines the time closer to the initial value “19:00” calculated in the step S1008, that is, “19:06” as the print end time of the “job D”. Then, the CPU 203 stores the table shown in FIG. 7D to which the calculation result is reflected in the HDD 209. The print end times in the table shown in FIG. 7D are determined so that the print end times will fall within the print end time period and the execution time periods of the jobs A, B, and D will not overlap. After the execution of the step S1015, the process proceeds to the step S1020.

In the step S1016, the CPU 203 calculates an initial value of the print end time on the basis of the result of the determination in the step S1003. In this example, since the “evening” is designated as the keyword of the print end time period and the reference value is determined as the last time in the step S1003, the initial value is calculated as “20:00” (see FIG. 6D).

In a step S1017, the CPU203 calculates the print end time of the “job A”. Specifically, the CPU 203 calculates the print end time of the “job A” as the initial value “20:00” calculated in the step S1016. Then, the CPU 203 stores the table shown in FIG. 7E to which the calculation result is reflected in the HDD 209. Further, the CPU 203 reads the printing requirement time of the “job A” (see FIG. 7B) from the HDD 209. Then, the CPU 203 calculates the print start time “19:55” of the “job A” by subtracting the printing requirement time “300 seconds” of the “job A” from the print end time “20:00” of the “job A”.

In a step S1018, the CPU 203 calculates the print end time of the “job B”. Specifically, the CPU 203 calculates the print end time of the “job B” as “19:55” that is the print start time of the “job A”. Then, the CPU 203 stores the table shown in FIG. 7E to which the calculation result is reflected in the HDD 209. Further, the CPU 203 reads the printing requirement time of the “job B” (see FIG. 7B) from the HDD 209. Then, the CPU 203 calculates the print start time “19:48” of the “job B” by subtracting the printing requirement time “420 seconds” of the “job B” from the print end time “19:55” of the “job B”.

In a step S1019, the CPU 203 calculates the print end time of the “job D”. Specifically, the CPU 203 calculates the print end time of the “job D” as “19:48” that is the print start time of the “job B”. Then, the CPU 203 stores the table shown in FIG. 7E to which the calculation result is reflected in the HDD 209. The print end times in the table shown in FIG. 7E are determined so that the print end times will fall within the print end time period and the execution time periods of the jobs A, B, and D will not overlap. After the execution of the step S1019, the process proceeds to the step S1020.

In the step S1020, the CPU 203 ends the execution of the program based on the flowchart shown in FIG. 10.

As described above, in the image forming apparatus 100, the print end time period designated in the print job from the host computer 230 and the print end time period stored in the HDD 209 may overlap. Further, for example, as shown in FIG. 7B, there may be the case where the jobs A, B, and D of which the print end time periods overlap are received. In such a case, the print end times of the jobs A, B, and D can be determined on the basis of the print end time period, the reference value, and the printing requirement times (a time determination step). Each print end time is included in the print end time period.

The user can grasp when the respective printed matters obtained by executing the jobs A, B, and D will be finished. This allows the user to go to the image forming apparatus 100 to pick up each printed matter without too early or too late. Although the CPU 203 has the function of the time determination unit for determining the print end time in this embodiment, this is not limiting. For example, a section that functions as the obtainment unit may be provided separately from the CPU 203.

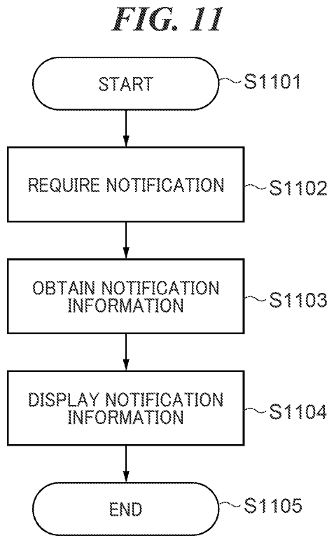

FIG. 11 is a flowchart showing a process of displaying a print time. Each process in the flowchart shown in FIG. 11 is achieved by the CPU 232 of the host computer 230 reading a program stored in a storage unit, such as the HDD 236, to the RAM 233 and executing the program. As shown in FIG. 11, in a step S1101, the CPU 232 starts execution of the program based on the flowchart shown in FIG. 11.

In a step S1102, the CPU 232 causes the display unit 231 to display the setting screen 501 (see FIG. 5) and receives a user operation to the button 506 on the setting screen 501. This allows the user to request any one of the tables (hereinafter, referred to as an “obtainment target table”) shown in FIG. 7C to FIG. 7E stored in the HDD 209 of the image forming apparatus 100. The obtainment of the obtainment target table is not limited to the operation of the button 506, and the obtainment target table may be obtained regardless of the presence or absence of the operation of the button 506.

In a step S1103, the CPU 232 obtains the obtainment target table from the HDD 209 of the image forming apparatus 100 and stores it in the RAM 233 of the host computer 230.

In a step S1104, the CPU 232 reads the obtainment target table obtained in the step S1103 from the RAM 233 and displays the list 505 of the setting screen 501 on the display unit 231. The list 505 includes only print jobs associated with the user ID. For example, when the obtainment target table is the table shown in FIG. 7C, although the table includes the jobs A, B, and D, the list 505 in FIG. 5 includes only the jobs A and D.

In a step S1105, the CPU 232 ends the execution of the program based on the flowchart shown in FIG. 11.

By performing such control, the user can be notified when the printed matter is finished.

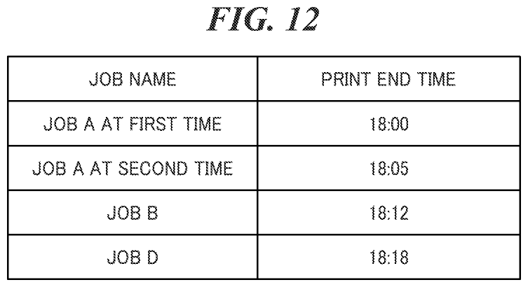

FIG. 12 is a table (modification) showing the relationships between the names of the print jobs for which the print end time periods are designated, the printing requirement time required for print execution, and the print end times at which print executions end. In this modification, a case where one print job is executed a plurality of times (for example, twice) is described as an example. Thus, the printed matter of the print job can be obtained by the number of times of execution of the print job.

In the table shown in FIG. 12, there are a “job A”, “job B”, and “job D” as the names of the print jobs. The reference value in the print end time period for the keyword “evening” is set to the head time. In this state, the print end time of the job A (first time) is “18:00”, the print end time of the job A (second time) is “18:05”, the print end time of the job B is “18:12”, and the print end time of the job D is “18:18”. The print end times can be obtained by a program based on the flowcharts shown in FIG. 9 and FIG. 10. In this case, for example, the job A (first time) and the job A (second time) may be handled as different print jobs.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application

No. 2023-020734, filed Feb. 14, 2023, which is hereby incorporated by reference herein in its entirety.

What is claimed is:

1. A printer comprising:
a reception unit configured to receive a print job in which a time period for executing printing is designated;
a time determination unit configured to determine a print time of the print job in the printer based on the time period and a reference value in the time period; and
a time notification unit configured to give notice of the print time.

2. The printer according to claim 1, further comprising a storage unit configured to store in advance the time period predicted to be designated in the print job together with the reference value,
wherein the time determination unit is able to determine the print time in a case where the time period designated in the print job received by the reception unit and the time period stored in the storage unit overlap.

3. The printer according to claim 2, wherein the storage unit stores time periods different from each other, and
wherein the reference value is provided for each of the time periods.

4. The printer according to claim 2, wherein the time period stored in the storage unit is any one of a time period in which the printing ends and a time period in which the printing starts.

5. The printer according to claim 1, wherein the reference value is changeable.

6. The printer according to claim 1, wherein the reference value is any one of a head time, a central time, and a last time in the time period.

7. The printer according to claim 1, wherein the reception unit receives the print jobs of which the time periods overlap, and
wherein the time determination unit determines the print time so that executions of the print jobs will not overlap in the time period.

8. The printer according to claim 7, further comprising an obtainment unit configured to obtain a printing requirement time required for print execution based on the print job received by the reception unit;
wherein the time determination unit determines the print time for each print job based on the time period, the reference value, and the printing requirement time.

9. The printer according to claim 8, wherein the print time is a print end time at which the printing ends, and
wherein the time determination unit determines the print end time of a subsequent print job by adding the printing requirement time of the subsequent print job to the print end time of a preceding print job among the print jobs that are sequentially executed within the time period.

10. The printer according to claim 8, wherein the print time is a print start time at which the printing starts, and
wherein the time determination unit determines the print start time of a subsequent print job by adding the printing requirement time of a preceding print job to the print start time of the preceding print job among the print jobs that are sequentially executed within the time period.

11. The printer according to claim 1, wherein the time notification unit gives notice of the print time in a case where the print time determined by the time determination unit falls within the time period.

12. The printer according to claim 1, wherein the time notification unit gives a notice that the print time determined by the time determination unit does not fall within the time period or that the printing is impossible.

13. The printer according to claim 1, wherein the time notification unit notifies a terminal apparatus that has transmitted the print job to the reception unit of the print time.

14. The printer according to claim 1, further comprising a display unit configured to display the print time,
wherein the time notification unit notifies the display unit of the print time.

15. A control method for a printer comprising:
a reception step of receiving a print job in which a time period for executing printing is designated;
a time determination step of determining a print time of the print job in the printer based on the time period and a reference value in the time period; and
a time notification step of giving notice of the print time.

16. A non-transitory computer-readable storage medium storing a control program causing a computer to execute a control method for a printer, the control method comprising:
a reception step of receiving a print job in which a time period for executing printing is designated;
a time determination step of determining a print time of the print job in the printer based on the time period and a reference value in the time period; and
a time notification step of giving notice of the print time.
